(19) United States
(12) Patent Application Publication
(10) Pub. No.: US 2006/0184323 A1
(43) Pub. Date: Aug. 17, 2006

(54) Method for providing route guidance to a destination to which a vehicle is driven

(75) Inventor: In-Ho Park, Yongin-si (KR)

Correspondence Address: DILWORTH & BARRESE, LLP, 333 EARLE OVINGTON BLVD., UNIONDALE, NY, 11553, US

(73) Assignee: Samsung Electronics Co., Ltd., Gyeonggi-do (KR)

(21) Appl. No.: 11/340,935

(22) Filed: Jan. 26, 2006

(30) Foreign Application Priority Data
Feb. 14, 2005 (KR) 2005-12028

(51) Int. Cl. G01C 21/34

(52) U.S. Cl. 701/211; 701/201

(57) ABSTRACT

A method for providing route guidance to a destination to which a vehicle is driven. When the vehicle enters a specific area, information about roads, points of interest, facilities, and other significant locations in driving directions from current location is displayed through a route guidance screen. A function for providing main direction guidance information displayed on a screen configured with road signs is implemented. When a driver selects one direction in a state in which guidance information about the driving directions is displayed, a navigation apparatus performs route guidance in the selected direction. If the vehicle reaches a corresponding position in the selected direction, the navigation apparatus senses a newly selected direction to continuously perform the route guidance. Accordingly, the driver can receive a fast route guidance service by selecting a direction of a destination through simple key manipulation without directly inputting a exact destination.

### PRIORITY

This application claims priority under 35 U.S.C. § 119 to an application entitled “Method for Providing Route Guidance to a Destination to Which a Vehicle is Driven” filed in the Korean Intellectual Property Office on Feb. 14, 2005 and assigned Serial No. 2005-12028, the contents of which are incorporated herein by reference.

### BACKGROUND OF THE INVENTION

1. Field of the Invention

The present invention generally relates to a route guidance method, and more particularly to a method for providing route guidance from the current location of a vehicle to a driving destination such that the directional information is provided on a navigation apparatus display configured with road signs.

2. Description of the Related Art

A conventional navigation apparatus utilizes map data based on a detailed level (i.e. magnification) to set a destination and compute a driving route. In this case, route computation is time-consuming and complex map manipulation is required when the destination is set.

A conventional navigation apparatus performs destination route guidance for a vehicle by computing a route from the current location to the destination. The destination can be set by a user selecting a target point on a map displayed on a screen, by an exact name input or a category search associated with a name, by retrieving registered positions or recent guidance positions, or by using voice recognition or a phone call. If the destination is set by one of the above-described destination setup methods, the navigation apparatus performs route guidance using a route computed through map data stored therein or route information downloaded from a server.

Among these destination setup methods, the destination setup method based on a category search associated with a name will be described in more detail with reference to FIGS. 1(A) and 1(B). FIGS. 1(A) and 1(B) are exemplary screens illustrating a destination setup process using the conventional category search associated with a name.

In FIG. 1(A), the user selects one of the main categories to search for a target destination. Then, sub-categories linked to the selected main category are displayed as illustrated in FIG. 1(B). The user then must select the target destination through a screen displaying the sub-categories. However, there is a problem in that a target destination search is time-consuming when the category depth is great. The category-based destination setup method also has a drawback in that it cannot be used when the user does not know a category to which the target destination belongs. When the user knows a main category of the target destination, but does not know a corresponding sub-category, the destination setup process is time-consuming.

FIG. 2 is another exemplary screen illustrating a method for setting a destination when the user directly inputs a destination name. When the user directly inputs the destination name using displayed soft keys rather than a keyboard, multiple points relating to the input destination name may be retrieved. Then, the user sets a target destination by selecting one of the retrieved points. In this case, however, because the user must input the destination name using these unfamiliar soft keys, a destination name input process is time-consuming. Although the destination name is input, many similar names may be listed. Accordingly, the user is inconvenienced because he or she must locate the target destination name from a list of similar names. There is also a problem because the search operation is not correctly performed and an undesired point is retrieved when a wrong name is input.

In another example of selecting a target destination on the map, the user must scroll the map many times and must repeat a scale change many times due to a limited screen size in order for the target destination to be retrieved. When the user does not know the area in which the target destination is located, it is impossible to locate the target destination on the map. Alternatively, when the user uses the destination setup method based on registered positions or recent guidance positions, he or she can receive only a route guidance service associated with previously registered positions. In this method, because the number of registered positions is limited, a route guidance search is also limited. Alternatively, in the destination setup method based on voice recognition, an error may occur due to voice recognition performance. When there are multiple names with the same pronunciation, an operation for processing the same names is time-consuming. The destination setup method using a phone call has the same problems as the voice recognition method. Also, when a phone call is made, communication fees are charged.

When a destination is set in the conventional navigation apparatus, a large number of key manipulations must be performed, so a target destination search is time-consuming. Accordingly, when a driver wishes to drive immediately after being seated in the vehicle, he or she is inconvenienced because a target destination setup operation with the conventional navigation apparatus is time-consuming. Moreover, because the driver must set the destination by manipulating many keys, he or she must input the destination information while the vehicle is stopped. Attempting to enter data while driving is dangerous.

### SUMMARY OF THE INVENTION

It is, therefore, an aspect of the present invention to provide a method for providing route guidance from the current location of a vehicle to a driving destination such that the directional information is provided on a navigation apparatus display configured with road signs.

The above and other aspects of the present invention can be achieved by a method for providing route guidance to a destination to which a vehicle is driven. The method includes the steps of determining if the vehicle enters a specific area for which main direction information is set, while the vehicle is driven; activating and displaying a position search function if the vehicle enters the specific area; and displaying information about main driving directions from current location if the position search function is selected.

### BRIEF DESCRIPTION OF THE DRAWINGS

The above and other aspects and advantages of the present invention will be more clearly understood from the following detailed description taken in conjunction with the accompanying drawings, in which:

FIG. 1A illustrates an exemplary screen for setting a destination using a conventional main category search associated with a name;

FIG. 1B illustrates an exemplary screen for setting a destination using a conventional subcategory search associated with a name;

FIG. 2 illustrates an exemplary screen for setting a destination when a user directly inputs a destination name;

FIG. 3 is a block diagram illustrating a navigation apparatus for performing a route guidance function such as a road sign function in accordance with an embodiment of the present invention;

FIG. 4 illustrates an exemplary screen for displaying a position search function in accordance with an embodiment of the present invention;

FIG. 5A is an exemplary screen for displaying guidance information about driving directions from current location in accordance with an embodiment of the present invention;

FIG. 5B illustrates a road sign for displaying guidance information about driving directions from current location;

FIG. 6A illustrates a method for designating a specific area in accordance with the first embodiment of the present invention;

FIG. 6B illustrates a method for designating a specific area in accordance with the second embodiment of the present invention;

FIG. 7 illustrates a level and block structure of map data applied to the present invention; and

FIG. 8 illustrates control flow for providing guidance information about driving directions from current location in the navigation apparatus in accordance with an embodiment of the present invention.

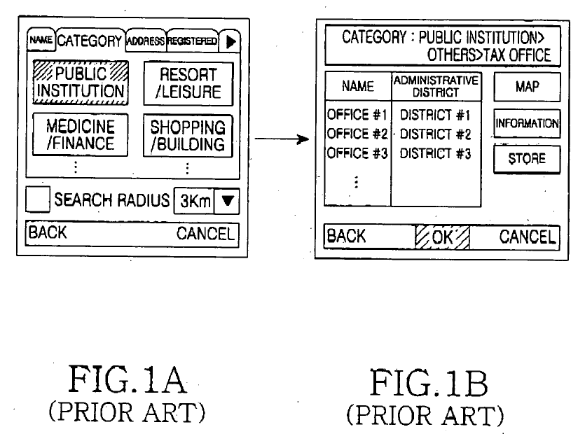

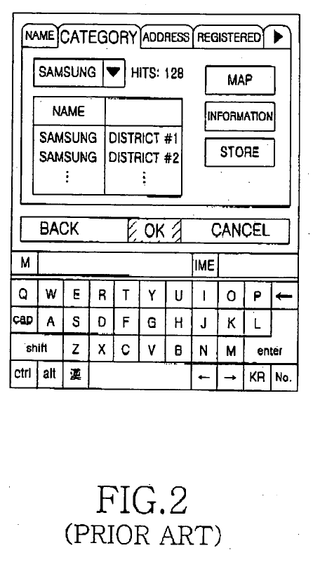

### DETAILED DESCRIPTION OF THE PREFERRED EMBODIMENTS

Preferred embodiments of the present invention will be described in detail herein below with reference to the accompanying drawings. In the drawings, the same or similar elements are denoted by the same reference numerals even though they are depicted in different drawings. In the following description, a detailed description of known functions and configurations incorporated herein will be omitted for conciseness.

The present invention implements a function for providing route guidance to a destination to which a vehicle is driven. Accordingly, the present invention displays guidance information about roads, points of interest, facilities, and other significant locations in driving directions from current location when the vehicle enters a specific area. That is, the present invention implements a function for providing main direction guidance information displayed within a road sign subscreen on a navigation apparatus display. When a driver selects one direction when guidance information about the driving directions is being displayed, the navigation apparatus performs route guidance in the selected direction. If the vehicle reaches a target position in the selected direction, the navigation apparatus senses a newly selected direction to continuously perform the route guidance. Accordingly, the driver can receive a fast route guidance service by selecting a direction of a destination through simple key manipulation without directly inputting an exact destination.

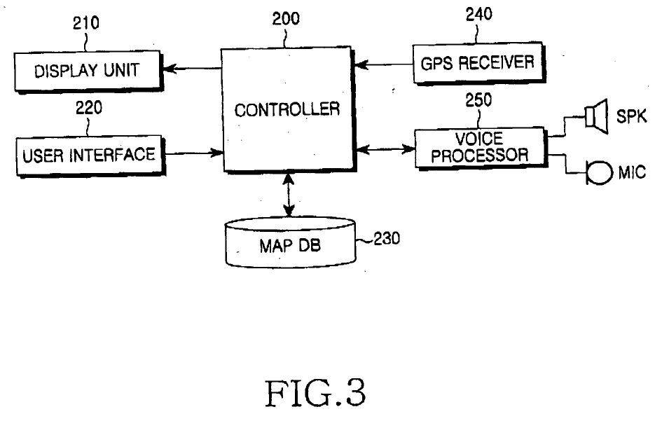

The configuration and operation of the navigation apparatus for implementing the above-described functions will be described with reference to FIG. 3. FIG. 3 is a block diagram illustrating a navigation apparatus for performing a route guidance function such as a road sign function in accordance with an embodiment of the present invention.

A controller 200 controls the overall operation of the navigation apparatus and controls a display unit 210 to display travel information associated with a current position provided by a global positioning system (GPS) receiver 240 such that the driver can receive an optimized driving route. More specifically, the controller 200 computes the current location of the vehicle on the basis of its speed, and determines the current location by selecting either a coordinate value of the current location received by the GPS receiver 240 or a coordinate value of the current location computed in the navigation apparatus. The controller 200 computes traveling information such as the speed of the vehicle as well as the current location thereof. The controller 200 loads map data of a peripheral area including the current location from a map database (DB) 230 on the basis of the computed travel information. The controller 200 controls the display unit 210 to visually display map information or controls a speaker coupled to a voice processor 250 to audibly output the map information.

More specifically, the controller 200 determines if the vehicle enters a specific area for which guidance information about driving directions is set while route guidance is provided on the basis of the current travel information. If the vehicle enters the specific area, a position search function is displayed such that main direction guidance information displayed on a road sign can be provided through a route guidance screen. When the position search function is displayed, the controller 200 determines if the driver has selected the position search function through a user interface 220. In the present invention, the user interface 220 is either a touch screen or a touch keypad. Accordingly, the user interface 220 outputs, to the controller 200, an input signal generated from the driver's touch input for selecting the position search function. When receiving the signal from the user interface 220, the controller 200 controls the display unit 210 to display information about roads, points of interest, and facilities in the main driving directions from that current location through a route guidance screen. That is, the present invention implements a function for providing main direction guidance information displayed on road sign subscreens on the navigation apparatus display.

Accordingly, when guidance information about driving directions is displayed, the controller 200 determines which direction has been selected by the driver. Then, the controller 200 performs route guidance in the direction selected by the driver. Because the map DB 230 stores in advance coordinate values associated with roads, points of interest, facilities, and other significant locations in main directions from the current location, the controller 200 performs route guidance from the coordinate value of the current location. That is, the present invention performs the route guidance by allowing the driver to select one driving direction at the current location without selecting an exact target destination. If the vehicle reaches a preset specific area while driving in the selected direction, the controller 200 receives an input of a new direction from the driver such that the navigation apparatus can continuously perform the route guidance. Accordingly, the driver can move to the target destination without setting a specific initial destination.

The map DB 230 stores data of specific areas based on guidance information about driving directions, and stores coordinate values of roads, points of interest, facilities, and other significant locations in main directions associated with the specific areas. This map DB 230 is embedded in the navigation apparatus. Alternatively, the map DB 230 may be implemented within a server for providing the route guidance.

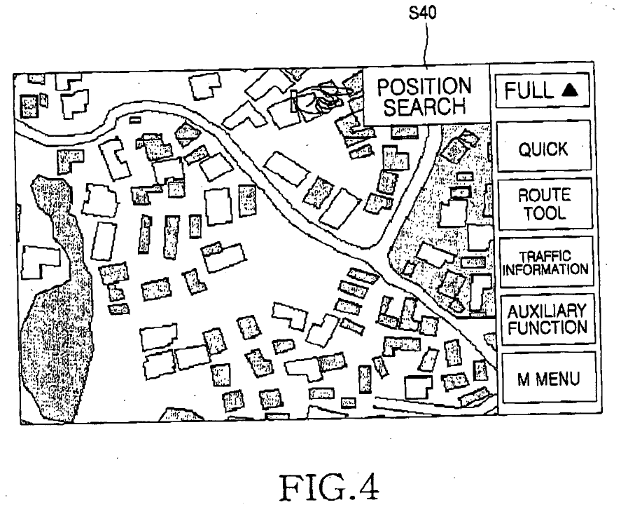

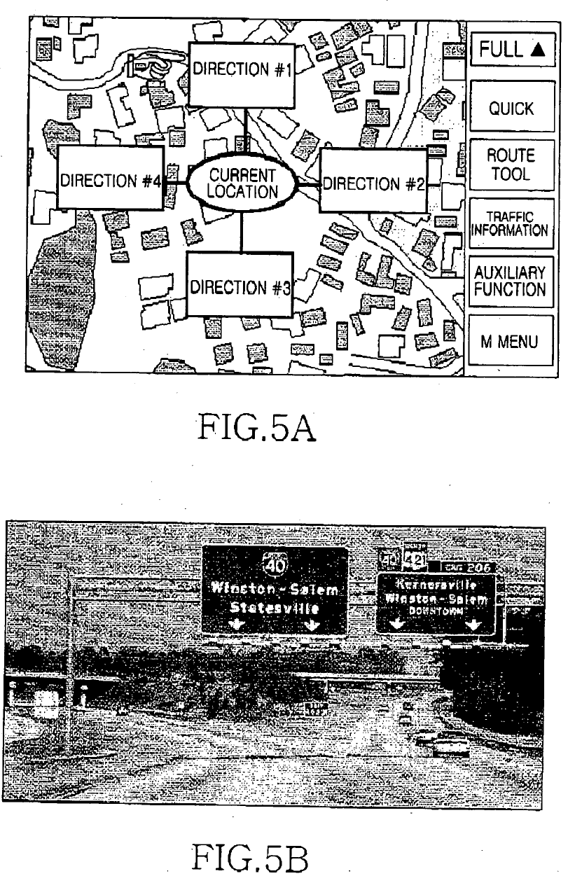

A concrete example in which the present invention is applied will be described in more detail with reference to FIGS. 4, 5A, and 5B. FIG. 4 illustrates an exemplary screen for displaying a position search function in accordance with an embodiment of the present invention. FIG. 5A illustrates an exemplary screen for displaying guidance information about driving directions from current location in accordance with an embodiment of the present invention. FIG. 5B illustrates a road sign for displaying guidance information about driving directions from current location.

The controller 200 of the navigation apparatus identifies the current location, and determines if the vehicle enters a specific area for which main direction information is set. If the vehicle enters the specific area, the controller 200 controls the display unit 210 to display ‘Position Search’ on a route guidance screen (S40 of FIG. 4) such that information about main driving directions from the current location can be identified. In a state in which ‘Position Search’ is displayed, the controller 200 controls the display unit 210 to display information about driving directions from the current location as illustrated in FIG. 5A. In this case, the navigation apparatus displays information about a maximum of 5 or 6 main directions by superimposing map data displaying the current location on the route guidance screen such that the driver can easily identify the driving directions from the current location. The information for each of the main driving directions is provided as blocks of space configured like road signs. The information provided in each “road sign” is the same type of directional information as is provided on the road signs illustrated in FIG. 5B. Accordingly, the driver can move in a destination direction using the guidance information provided by the “road sign”.

The driver views route guidance information displayed on the “road sign” as illustrated in FIG. 5B, determines a driving direction at the current location, and moves to a destination. Similarly, the driver views the route guidance screen for displaying the guidance information about main directions as illustrated in FIG. 5A, and determines a driving direction in accordance with the present invention.

For example, the driver can select one of the directions displayed on the route guidance screen through a touch input in accordance with an embodiment of the present invention. Accordingly, if a touch input is performed, travel information about an optimum route in the selected direction is continuously updated, such that the updated information can be provided to the driver. In a state in which main direction information is continuously displayed in accordance with another embodiment of the present invention, an information display operation is completed and only map data according to a travel route of the vehicle is displayed when the vehicle reaches a target position in the selected direction.

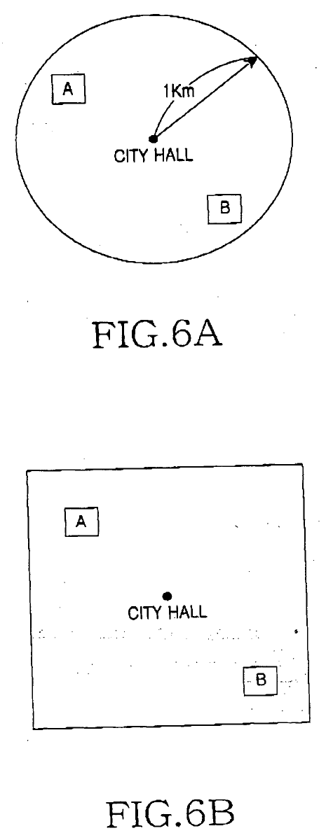

Now, a process for storing guidance information associated with specific areas in the DB 130 will be described. Specific area setup methods are classified into two methods. The specific area setup method in accordance with the first embodiment of the present invention will be described with reference to FIG. 6A.

First, when map data is organized, specific areas based on guidance information about driving directions can be designated arbitrarily. The guidance information about the specific areas is organized on the basis of main points and administrative districts. For example, the guidance information about the specific areas can be extended from a main point of a capital city to metropolitan, rural, and remote areas. The specific areas may be set by referring to road signs arranged therein.

For explanation of an embodiment of the present invention, it is assumed that the main point is a city hall. A specific area can be designated according to the main point of the city hall as illustrated in FIG. 6A. That is, the specific area can be set within a predetermined radius of the main point. For example, when the main point is the city hall, the specific area can be set within a radius of 1 kilometer of the city hall.

If the specific area is set within the radius of 1 kilometer of the main point, the same guidance information about driving directions is provided within the specific area even though the vehicle is located at any one of points A and B. Accordingly, the same information about the main directions from the current location is displayed on the route guidance screen in FIG. 5A even though the driver selects any one of the points A and B.

The information about the main directions within the above-described specific area indicates roads, points of interest, facilities, and other significant location in the main directions from the current location. Corresponding position coordinates mapped to the main direction information are stored in a database. A process for storing information will be described.

Main guidance positions and points of interest (POIs) are designated by longitude-latitude coordinates. This designation can be made in advance by a driver or service provider. The main direction information includes information about a road, a point of interest or facilities with high recognition or importance in driving directions within a specific area. As the vehicle enters the specific area, the main driving direction information displayed on portions of the route guidance screen configured as road signs and providing directions as they might be arranged on an actual road sign. It is difficult for certain POIs such as a bridge to be designated by specific coordinates in FIG. 5A. So for example, when the vehicle driven in the southerly direction is taken into account, a position coordinate value of a bridge may be set to that of a north end or middle point of the bridge.

Another method for setting a specific area in accordance with the present invention will be described with reference to FIG. 6B. FIG. 6B illustrates a method for designating a specific area in accordance with the second embodiment of the present invention.

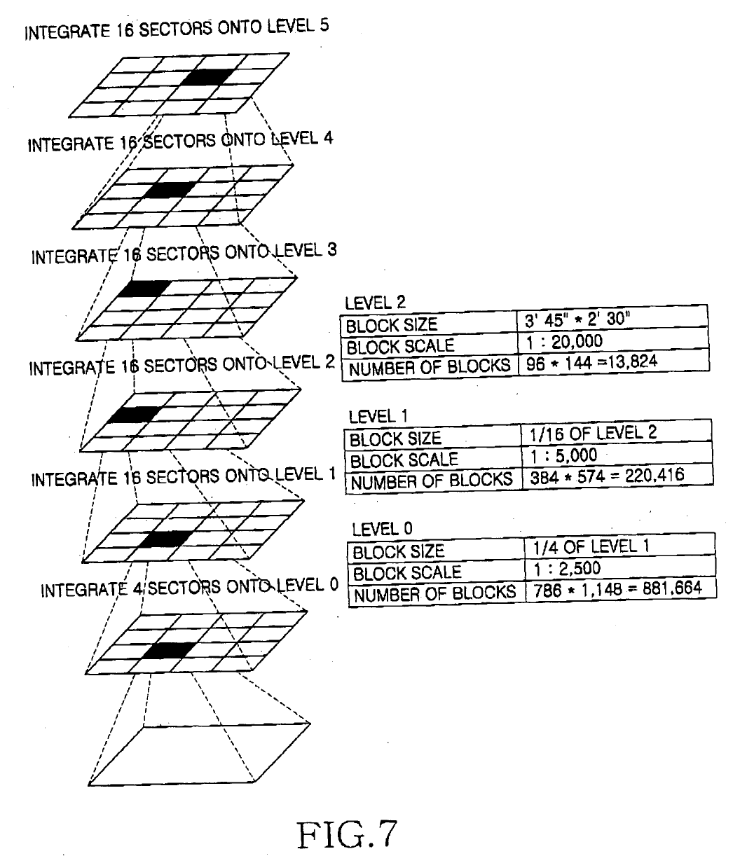

In accordance with the second embodiment of the present invention, the specific area is designated on the basis of a unit block size of a unit level. Hereinafter, it is assumed that a specific area is defined on-the basis of a block of Level 0 as illustrated in FIG. 7. FIG. 7 illustrates a level and block structure of the map data applied to the present invention. In accordance with the second embodiment of the present invention, a specific area is designated according to each main point or administrative district. Route guidance for providing information about driving directions from the current location is performed within the designated specific area.

For example, when a unit block of Level 0 includes a main point, it is assumed that the main point is a city hall as illustrated in FIG. 6B. If the current location of the vehicle is identified by a coordinate value within a specific area, the navigation apparatus activates and displays a ‘Position Search’ function as illustrated in FIG. 4. When the driver selects the ‘Position Search’ function, information about main driving directions from the current location is displayed as illustrated in FIG. 5A. In this case, the main direction information is stored in advance in Level 0. Accordingly, when the driver is located in an area based on Level 0 with the center of the city hall, the same main direction information is displayed on the route guidance screen even though the vehicle moves to any one of the points A and B, because the same main direction information is stored in Level 0 on the basis of the center of the city hall.

Similarly, position coordinates mapped to roads, points, facilities, and others in main directions within a specific area corresponding to Level 0 are stored in advance in a database. In a process for storing the position coordinates in the database, a list of destinations can be registered in a corresponding block of Level 0. A map DB may differ according to a map data service provider. For example, lists of roads, points of interest, facilities, and other significant locations in driving directions of the vehicle are designated on a block-by-block basis. For example, highway entrance points, road entrance points, bridge or tunnel entrance points, POIs, and others may be designated as main direction information. The route guidance screen provides information on one-direction movable from a current location as illustrated in FIG. 5B, and the direction information can include POI and bridge information.

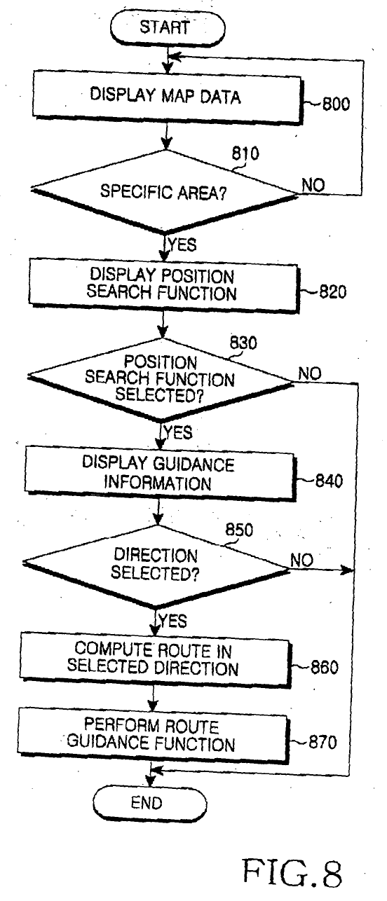

The control flow for providing guidance content based on main directions from the current location will be described with reference to FIG. 8. FIG. 8 is a flow chart illustrating control flow for providing guidance information about driving directions from current location in the navigation apparatus in accordance with an embodiment of the present invention.

The controller 200 computes a driving route of the vehicle, and controls the display unit 210 to display map data on a route guidance screen on the basis of the computed driving route in step 800. In a state in which a current driving route is displayed, the controller 200 determines the current location using GPS position information received through the GPS receiver 240. In step 810, the controller 200 determines if the vehicle enters an area in which a ‘Position Search’ function can be activated. If the vehicle enters an area in which the ‘Position Search’ function can be activated, i.e., a specific area, the controller 200 proceeds to step 820 in which the ‘Position Search’ function is activated and displayed on a predetermined display area of the route guidance screen as illustrated in FIG. 4. The controller 200 determines if the driver has selected the ‘Position Search’ function in step 830. If the ‘Position Search’ function has been selected, the controller 200 proceeds to step 840 to control the display unit 210 to display guidance information associated with main driving directions from the current location, i.e., main driving direction information. The main driving direction information includes names of roads, points of interest, facilities, and other significant locations in driving directions from the current location as would be displayed on actual road signs. Then, the controller 200 proceeds to step 850 to determine if one of the main directions displayed on the route guidance screen has been selected and input. If one direction has been selected, the controller 200 proceeds to step 860 to compute a route in the selected direction. Then, the controller 200 proceeds to step 870 to perform a route guidance function. In this case, if the vehicle nears target position coordinates in the selected direction, i.e., within a radius of 100 meters thereof, while the controller 200 performs the route guidance function, the route guidance function is terminated.

As is apparent from the above description, the present invention can be used when a user desires to drive a vehicle from an unfamiliar position to a target destination or point through a navigation apparatus. More specifically, the present invention is useful when the user does not know an accurate destination position or name, or available category information. Through a method in accordance with the present invention, the user easily drives the vehicle from a specific point to a main road or main facilities or in a main direction through a route guidance service. Accordingly, the user can reach a target destination. The present invention can prevent time wastage due to a problem conventionally incurable in setting a destination in the navigation apparatus. In the present invention, the driver can receive a fast route guidance service by selecting a direction of a destination through simple key manipulation.

Although preferred embodiments of the present invention have been disclosed for illustrative purposes, those skilled in the art will appreciate that various modifications, additions, and substitutions are possible, without departing from the scope of the present invention. Therefore, the present invention is not limited to the above-described embodiments, but is defined by the following claims, along with their full scope of equivalents.

What is claimed is:

1. A method for providing route guidance to a destination to which a vehicle is driven, comprising the steps of:
determining if the vehicle enters a specific area for which main direction information is set, while the vehicle is driven;
activating and displaying a position search function if the vehicle enters the specific area; and
displaying information about main driving directions from a current location if the position search function is selected.

2. The method of claim 1, further comprising the steps of:
determining if one of the main driving directions is selected;
computing a route in a selected direction if one direction is selected; and
performing a route guidance function using information of the computed route.

3. The method of claim 2, further comprising the step of:
terminating the route guidance function when the vehicle enters within a predetermined radius of a target position in the selected direction.

4. The method of claim 2, wherein the step of performing the route guidance function comprises the steps of:
loading, from a map database, a map data of a peripheral area including the current location on a basis of the computed route information; and
displaying the loaded map data.

5. The method of claim 2, wherein the step of computing the route in the selected direction comprises the steps of:
extracting, from a map database, position coordinates in the selected directions; and
computing the route using the extracted position coordinates.

6. The method of claim 1, wherein the information about the main driving directions includes information about at least one of roads, points of interest, and facilities in the main driving directions in which the vehicle can be driven in the specific area.

7. The method of claim 1, wherein the specific area is set according to points of interest or an administrative district.

8. The method of claim 1, wherein the specific area is set within a predetermined radius of points of interest.

9. The method of claim 8, wherein when the specific area is set within the predetermined radius of the points of interest, guidance information about driving directions is identical within the specific area.

10. The method of claim 1, wherein the step of displaying the information about the main driving directions comprises the step of:
displaying a result obtained by superimposing information about a maximum of 6 directions on map data for displaying the current location.

11. The method of claim 1, wherein the specific area is defined on a basis of a unit block of a predetermined level.

12. The method of claim 1, wherein the main direction information is set by referring to at least one road sign arranged within the specific area.
